(19) United States
(12) Patent Application Publication
(10) Pub. No.: US 2008/0133738 A1
(43) Pub. Date: Jun. 5, 2008

(54) PROVIDER PRESENCE INFORMATION WITH LOAD FACTOR

(76) Inventors: Robert Knauerhase, Portland, OR (US); Mic Bowman, Beaverton, OR (US); Paul Brett, Hillsboro, OR (US); Robert Adams, Lake Oswego, OR (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/566,544

(22) Filed: Dec. 4, 2006

(51) Int. Cl. G06F 15/173

(52) U.S. Cl. 709/224

(57) ABSTRACT

In some embodiments, a system includes a service provider having a memory and a processor coupled to each other. The service provider is adapted to provide at least one service instance. A presence generating program is adapted to be located in the memory and the processor adapted to execute the presence generating program to generate provider presence information, with the provider presence information including a provider status. A load monitoring program, in communication with the service provider, generates at least one load factor in response to monitoring the at least one service instance.

### BACKGROUND

1. Technical Field

Embodiments of the present invention are related to the field of electronic devices, and in particular, to presence systems.

2. Description of Related Art

A presence and instant messaging (IM) system allows clients (users) to subscribe to each other and be notified of changes in state, and for clients to send each other short instant messages. With an IM service, one or more IM servers may be used. The IM server automatically manages the presence information for the clients, distributing the information as needed or requested. Presence is a way for a client to make its connection or availability known or available to other clients. Typically, operation of an IM service requires both the recipient (a client) and the sender (also a client) of the instant message to be online at the same time.

A network may have many attached devices offering and/or seeking services, capabilities and/or resources of other devices. It is often difficult to locate devices offering particular services. To facilitate locating and tracking devices and their services, various “web service” or “directory service” technologies have been implemented. An overloaded service provider may result in an unreasonable amount of time to receive the requested service, or the client may never receive the requested service.

### BRIEF DESCRIPTION OF THE DRAWINGS

FIG. 1 is a diagram of an IM system, according to some embodiments of the present invention.

FIG. 2 is a diagram of provider presence information, according to some embodiments of the present invention.

FIG. 3 is a flow chart of operations of a load monitoring program and its interface with a presence generating program in a service provider in FIG. 1, according to some embodiments of the present invention.

FIG. 4 is a flow chart of operations of a server presence program in an IM server in FIG. 1 for obtaining provider presence information from service providers and for forming resource records, according to some embodiments of the present invention.

FIG. 5 is a flow chart of a client presence program of a client in FIG. 1, according to some embodiments of the present invention.

FIG. 6 is a flow chart of operations of a server presence program of the IM server in FIG. 1 for distributing provider presence information to clients.

FIG. 7 is a block diagram of an illustrative IM server which may form part of the IM system of FIG. 1, according to some embodiments of the present invention.

FIG. 8 is a block diagram of an illustrative client which may form part of the IM system of FIG. 1, according to some embodiments of the present invention.

FIG. 9 is a block diagram of an illustrative service provider which may form part of the IM system of FIG. 1, according to some embodiments of the present invention.

### DETAILED DESCRIPTION OF ILLUSTRATIVE EMBODIMENTS

In the following description, for purposes of explanation, numerous details are set forth in order to provide a thorough understanding of the disclosed embodiments of the present invention. However, it will be apparent to one skilled in the art that these specific details are not required in order to practice the disclosed embodiments of the present invention. In other instances, well-known electrical structures and circuits are shown in block diagram form in order not to obscure the disclosed embodiments of the present invention. The term “coupled” shall encompass a direct connection, an indirect connection or an indirect communication.

In the following description, terminology is used to discuss certain features of various embodiments of the present invention, with the use of the following terms:

An “instant message (IM) server” may provide a “presence service” and an “instant message service”, with the presence service accepting “presence information”, storing it, and distributing it and the instant message service accepting from clients and delivering “instant messages” to clients. The instant message service may provide on-line chats for clients. The presence service may provide “client presence information” to watcher clients, for example, in the form of buddy lists showing online clients. According to the various embodiments of the present invention, the presence service also may provide “provider presence information” describing one or more service providers to watcher clients.

A “client” or “client computer” may include any device that is capable of receiving presence information. Examples of such clients may include a cellular phone, personal digital assistant (PDA), laptop, workstation, personal computer, blackberry device, good link device, or any other computing device or mobile device.

A “presentity” may be a client (“presentity client”) or a service provider and may provide presence information, in accordance with a presence protocol, to an IM server. As a presentity, a service provider may provide “provider presence information” to the IM server and the presentity client may provide “client presence information” to the IM server.

A “watcher client” may be a client that receives client presence information from the presence service of the IM server in accordance with a presence protocol. A watcher client may be characterized as an “IM watcher client” when watching for client presence information and/or a “service watcher client” when watching for provider presence information.

The “watcher client” also may be categorized as a client who is a “fetcher” or a “subscriber”. A fetcher may simply request the current value of some presentity's presence information from the presence service. In contrast, a subscriber may request notification from the presence service of (future) changes in some presentity's presence information. A special kind of fetcher is one that fetches information on a regular basis and may be called a “poller”.

A “presence protocol” defines the interaction between the presence service, presentities, and watchers and is used to distribute presence information. Presence information is carried by the presence protocol. An example of a presence protocol is given in the informational Request for Comments (RFC) 2778 entitled, “A Model for Presence and Instant Messaging”, by M. Day, J. Rosenberg, and H. Sugano (The Internet Society, Feb. 2000).

A “service provider” may provide one or more services (e.g., distributed services) to one or more clients. In accordance with the various embodiments of the present invention, the service provider may be characterized as a presentity in that it provides provider presence information about its services to one or more IM servers. In some embodiments, the services may be web services. Some examples of such services may include providing news, stock quotes, MP3 files, distance learning classes, organizational procedures, etc.

“Presence information” may consist of an arbitrary number of elements, and may include “provider presence information” describing one or more the service providers and “client presence information” describing one or more clients.

“Provider presence information”, which may describe one or more service providers, may include for each service provider at least a communication address and a “provider status”. Prior to distribution to clients, the provide presence information may include at least one “load factor”. In some embodiments, the provider presence information may include one or more available “service instances”, with there being a load factor for each service instance or a load factor for an aggregate of service instances. In some embodiments, the provider presence information also may include additional elements, such as service qualifying characteristic(s). Examples of the service qualifying characteristics may include hosting environment of a service instance or service provider, supported service interfaces of a service instance or service provider, capabilities of a service instance or service provider, location (geographical or topological location) of a service provider and/or other like factors which qualify a given service instance or service provider.

“Status” is part of the presence information and may include “client status” in the client presence information and “provider status” in the provider presence information. “Client status” refers to the availability (e.g., online) of a client to receive instant messages. In accordance with various embodiments of the present invention, “provider status” may have at least two states: the service provider is “available” or the service provider is “unavailable”. In some embodiments, “available” may mean “online” (connected and available) with respect to the “network”.

A “service instance” may be an individual service or subservice of a specific service of a service provider. In some embodiments, there may be one or more types of subservices, with each subservice being a server program or procedure for handling a particular type of client interaction.

A “load factor” of a service instance or an aggregate of service instances may be expressed in a number of ways and conveys the extent to which service resources are being used. For example, the load factor may be expressed as a percentage of total use capacity for the service instance or aggregation of service instances. In one illustrative embodiment, the load factor for a service instance or aggregate of service instances may be calculated as a product of its average response time and its average hits per time unit; however, the load factor may be characterized using many different formulas.

An “overload condition” of a service instance or aggregate of service instances may describe a situation wherein the processing and/or resource capabilities of a service instance or aggregate of service instances system are used to the point where the efficiency of the service instance or aggregate of service instances becomes degraded. In some embodiments, an overload condition may be considered to have come into existence when an “overload threshold value” of the load factor is exceeded, which may result in the provider status being changed from “available” to “unavailable”.

“Service selection criteria” may be criteria which are used by a client, when examining the provider presence information for a given service provider, to select for connection a service instance included in the provider presence information. In some embodiments, the service selection criteria may include the availability of a service instance or service provider and a criterion based at least in part on a load factor. In other embodiments, the service selection criterion also may include factors based on one or more service selection characteristics.

A “network” for interconnecting IM servers, clients and/or service providers may include one or more networks to facilitate and/or coordinate the exchange of information, such as instant messages and presence information. Examples of the one or more networks may include packet networks (e.g., the internet), intranets, wired networks, wired telephone networks, wireless telephone networks, satellite networks, cable networks, wide area networks (WANs) and/or local area networks (LANs). For example, in one embodiment, the IM servers may be interconnected by the internet.

A “link” may be one or more information-carrying mediums (e.g., electrical wire, optical fiber, cable, bus, or wireless signaling technology) of the network.

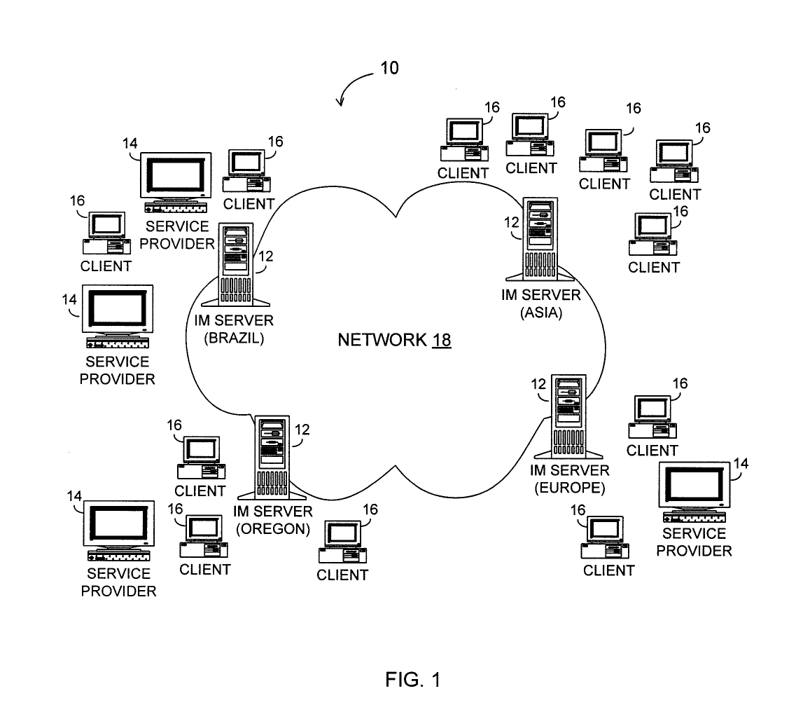

With reference to FIG. 1, there is illustrated a presence and instant messaging (IM) system 10, according to some embodiments of the present invention, which implements a presence protocol. The IM system 10 includes a plurality of IM servers 12, a plurality of service providers 14, and a plurality of clients 16 which may be communicatively coupled to the network 18 and therefore may be communicatively coupled to each other.

As an overview, the service providers 14 send provider presence information over the network 18 to the IM servers 12 using the presence protocol. In some embodiments, the elements of the provider presence information for a given service provider 14 may include a communication address, provider status, and at least one load factor. The at least one load factor may be added to the provider presence information at the given service provider 14 or at one of the service providers 14, depending upon the embodiment.

In some embodiments, the provider status being set to “available” in the provider presence information is an indication that one or more service instances are available at a given service provider 14, without the need for having to specifically list the service instances in the presence provider information. In other embodiments, the provider presence information may not only include the communication address, the provider status, and the at least one load factor, but it also may include a list of one or more service instances. A given service instance may have an associated load factor indicating resource usage for that specific service instance. Alternatively, a load factor may be associated with an aggregate of service instances, with the aggregate of service instances including all or part of the service instances of the service provider 14. In this case, the associated load factor indicates resource usage for the aggregate of the service instances.

Additional elements may be included in the provider presence information, such as service selection characteristics described above, which may qualify a service provider 14 or a service instance of a service provider 14. In other words, the load factor in conjunction with the service selection characteristics, may be used for selecting a service provider 14 or a service instance of a service provider 14. In any case, at least one service selection criterion, as defined above, is based at least in part on the load factor.

In providing its presence service, one of the IM servers 12 may execute a server presence program to receive the provider presence information from one or more service providers 14 via the network 18, to store the provider presence information in memory, and to distribute the provider presence information over the network 18 to one or more watcher clients 16. The watcher client 16 may have a client presence program for receiving the provider presence information.

In some embodiments, a given service provider 14 may include a load monitoring program for monitoring the extent to which a service instance or an aggregate of service instances are being utilized, with this utilization being characterized by a repeatedly calculated “load factor”. The load monitoring program may set an “overload threshold value” for a given service instance or aggregate of service instances. When the load factor for the given service instance or aggregate of service instances is exceed, this may mean that there may be an “overload condition”. As previously defined, an overload condition may be when the processing and/or resource capabilities of a service instance or aggregate of service instances are used to the point where the efficiency of the service instance or aggregate of service instances becomes degraded. As a result of this overload threshold value being exceeded, the load monitoring program may cause the provider status of the given service provider 14 to be changed to “unavailable”, if it was previously set to “available”. Likewise, when the load factor falls below (or equals) the threshold value, then the load monitoring program may cause the provider status to be changed to “available” from “unavailable”. In this embodiment, a presence generating program may generate the provider presence information and may be responsive to a command from the load monitoring program to change the provider status.

In other embodiments, the load monitoring program for monitoring at least one service instance of a service provider 14 may be situated in a location in the network 18 which is remote to the service provider 14 being monitored, with such monitoring being implemented by communications over the network 18 between the load monitoring program and the monitored service provider 14. Although any number of locations in the network 18 may include the load monitoring program, in one illustrative example, the load monitoring program may be included in one of the IM servers 12. Upon determining at least one load factor for at least one service instance of the service provider 14, the load monitoring program may cause the provider presence information for the service provider to be modified to include the at least one load factor.

In some embodiments, the presence generating program at the service provider 14, in response to receiving at least one load factor from the load monitoring program, may modify the provider presence information at the service provider 14 to include the at least one load factor and then the presence generating program may distributed the modified provider presence information over the network 18 to one or more of the IM servers 12. In other embodiments, the provider presence information may be distributed to one or more IM servers 12 and then a server presence program at one of the IM servers 12, in response to receiving at least one load factor from the load monitoring program, may modify the provider presence information to include at least the one load factor.

Using the presence protocol and service, the service providers 14 may update the provider presence information previously provided to the IM servers 12 and the IM servers 12 may update the provider presence information previously provided to the watcher clients 16. In some embodiments, the IM servers 12 may share the provider presence information among each other, so that watcher clients 16 may obtain updated presence information from any of the IM servers 12 that share the provider presence information. In accordance to the presence service provided by the IM server 12, the watcher client 16 may obtain the provider presence information by being a fetcher (explicitly asking the IM server 12) or by being a subscriber (e.g., automatic notification by the IM server 12). In some embodiments, where the load monitoring program is not located at the service provider 14 being monitored by the load monitoring program, then updates for the at least one load factor may be received by the IM server 12 from a location other than that where the service provider 14 is located.

In some embodiments, the IM server 12 may distribute provider presence information to the watcher clients 16 regardless of whether the provider status is set to be “available” or “unavailable”. In other embodiments, distribution of the provider presence information by the IM servers 12 to the watcher clients 16 may be limited to provider presence information with a provider status of “available”. The embodiments discussed hereinafter will be illustrated by having the presence information distributed even if the provider status is set to “unavailable”.

Updates to the provider presence information may also include updates to the load factors for the service providers 14. Hence, the IM servers 12, and then watcher clients 16, may have updates that reflect changing load factors for the service providers 14. Moreover, in the event that one or more service providers 14 change their provider status, the IM servers 12, and then the watcher clients 16, may be provided this updated status information as a part of the updated provider presence information. This change in provider status includes status resets caused by the previously-described overload condition, along with status resets caused by other factors.

The watcher client 16 may check the provider presence information distributed by one of the IM servers for the availability of the specific service provider 14 and possibly also for a specific service instance of the service provider 14, to determine if the watcher client 16 wants to connect to a given service provider 14 to obtain services from that service provider 14. In some embodiments, if the provider presence information for a given service provider 14 has a provider status indicating “available”, the watcher client 16 may check its load factor, and if acceptable, may send a service request to the given service provider 14. In other embodiments, where there are more than one service provider available (e.g., same service instance from different service providers 14), then the watcher client 16 may select the service provider 14 with the lowest load factor. In other embodiments, the above-defined service selection characteristics may be consider in conjunction with the load factor in the selection of a service provider by the watcher client 16.

In other embodiments, the watcher client 16 also may search for a specific service instance in a list of one or more service instances contained in the provider presence information for one or more service providers 14. After having located a desired service instance, then the watcher client 16 may consider a load factor for that specific service instance or for an aggregate of service instances prior to deciding to connect to the service provider 14 to obtain services from the selected service instance. In other embodiments, in making its decision to select a particular service instance, the watcher client 16 may consider service selection characteristics contained in the provider presence information prior to evaluating the load factor or in conjunction with evaluating the load factor. Upon selecting a service provider 14 or a particular service instance of a service provider 14, the watching client 16 may use the communication address to submit a service request to the selected service provider 14.

Because the presence information is maintained by and between the IM servers 12 in the infrastructure, the IM servers 12 themselves are free to alter or annotate provider presence information to affect the behavior in ways beneficial to the client 16, the presence service, or the overall IM system 10. For example, even if a service instance in Brazil is lightly loaded, if the network link between two intermediate IM servers 12 (or the link between the Brazilian instance and its IM server) is busy, the IM servers 12 of the IM system 10 may change the provider presence information of a Brazilian service instance to reflect that, without the Brazilian service provider 14 making the change. The “Brazilian instance” in this example is meant to be an illustrative service instance of a service provider 14, which is located, for example, in Brazil (see FIG. 1).

In some embodiments, one or more of IM servers 12 may include a connection monitoring program which is in communication with the server presence program. The connection monitoring program, based upon its monitoring of at least one network condition, may provide a presence-changing request to the server presence program requesting the current provider presence information be changed. A change to the provider presence information caused by such a presence-changing request from the connection monitoring program may be characterized as an IM server initiated change, as opposed to service provider initiated change. For example, the connection monitoring program may send a service-requesting change to the server presence program which causes the server presence program to change the provider status of the provider presence information for a given service provider. In some embodiments, the monitored network condition may be one or more link impairments. For example, the connection monitoring program may monitor a link load condition for a given link or it may detect whether the link has a busy signal. However, in other embodiments, the connection monitoring program may monitor multiple links for other signs of data traffic congestion or impairment in the network 18.

In some embodiments, the connection monitoring program of the IM server 12 may monitor the links extending from the IM server 12 back to the service providers 14. For example, the monitored links may include the links connecting intermediate IM servers 12 (those IM servers interposed between a given IM server 12 having the particular monitoring program and the service provider 14 having a specific service instance (e.g., Brazilian instance). In other words, with respect to the source service provider 14, the connection monitoring program may monitor links “downstream” of the IM server 12 having the connection monitoring program. As one illustrative example, when the server presence program requests updates to the provider presence information from one or more service providers 14, the connection monitoring program may expect a reply (e.g., updates and/or an acknowledgment). Failing to obtain such an acknowledgment, the connection monitoring program may assume a link impairment problem (e.g., link busy between the service provider 14 and the IM server 12) and may request that the server presence program reset the provider status to “unavailable”. This modified provider status then may be provided to other IM servers and the watcher clients 16. In some embodiments, the load monitoring program may be merged into the connection monitoring program, when both are located at a given IM server 12. In this case, one of the network conditions monitored by the connection monitoring program may be considered to be at least one load factor of at least one service provider 14, in addition to or instead of the network condition of a link impairment.

At least the distribution of the provider presence information by the IM servers 12 to the watcher clients 16 essentially may be in accordance to the same presence protocol established for distributing client presence information to IM watcher clients 16 for subsequent instant messaging. In some embodiments, the receipt of the provider presence information by the IM server 12 from the service providers 14 essentially may be in accordance with the same presence protocol established for receiving client presence information from presentity clients 16 and used for subsequent instant messaging. The IM system 10, according to some embodiments of the present invention, will now be described in more detail.

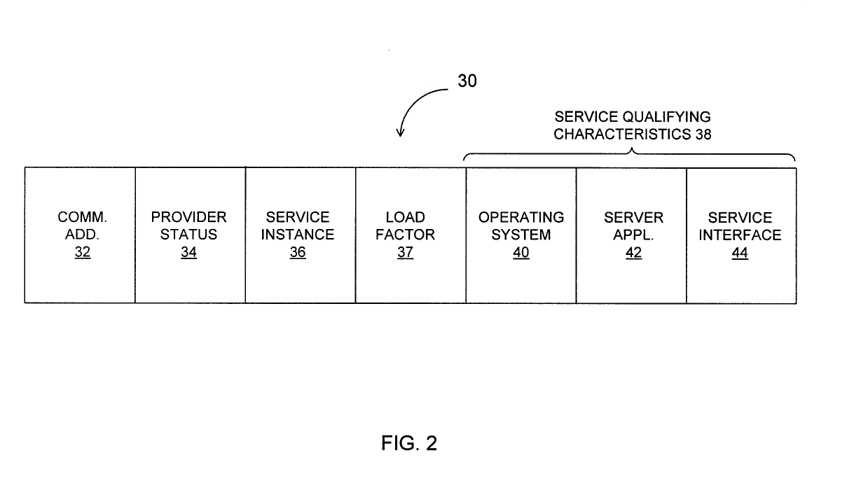

With reference to FIG. 2, a diagram of an illustrative resource record 30 is shown, according to some embodiments of the present invention. There may be one or more resource records 30 established in a memory of the IM server 12 of FIG. 1. Each resource record 30 may contain the “provider presence information” defined above for a given service provider 14. As described above in the definitions, the provider presence information contained in a specific resource record 30 may include a number of elements, with the type and number of elements varying.

With reference to FIGS. 1 and 2, the resource record 30 is illustrated with provider presence information for a given service provider 14. The provider presence information included in the resource record 30 is illustrated with a communication address 32, a provider status 34, a single available service instance 36, and a load factor 37 for the available service instance. Additionally, service qualifying characteristics elements 38 of the provider presence information are illustrated with hosting environment elements of an operating system 40 and server application software 42. Additionally, a service interface element 44 is included. In other embodiments, a location element may be included.

The communication address 32 may include, for example, an Internet Protocol (IP) address of the service provider 14. In some embodiments where the service provider has servers with virtual machines (VMs), then the communication address may also include a VM identifier. The previously-defined “provider status” may indicate whether a given service provider 14 is available or unavailable (e.g., online). Although only one service instance 36 is shown for the service provider 14, the resource record 30 may include a list of service instances that are available when the provider status is set to “available”. In some embodiments, for each service instance that is available and listed in the provider presence information, the resource record 30 may also include an associated load factor.

In some embodiments, “service qualifying characteristics” elements 38 may be included for each service instance, with these elements 38, in addition to the load factor, being used by the watcher client device 16 for selecting a given service instance. The service qualifying characteristics elements 38 may include hosting environment elements, supported service interfaces, supported capabilities, location and/or other like factors to use in selecting a given service instance. In some embodiments, the service qualifying characteristics 38 may be associated with the service provider 14 but not a specific one of a plurality of service instances; hence, the characteristics 38 are just used to select the service provider 14. Likewise, as previously described, the load factor may be for an aggregate of service instances; hence, the load factor is used just to select the service provider 14, but not to select a specific service instance of a plurality of service instances of the service provider 14.

The data structure of the resource record 30 shown in FIG. 2 may be characterized as including a presence string of a variable number of service instances (although only one service instance is shown); however, the resource record 30 may take many different forms. For example, in another embodiment, the resource record 30 may have a specified field associated with a given service instance and a digital one may indicate that it is available and digital zero may indicate that it is not available. Similar data structures may be used for the service qualifying characteristics associated with the service instances.

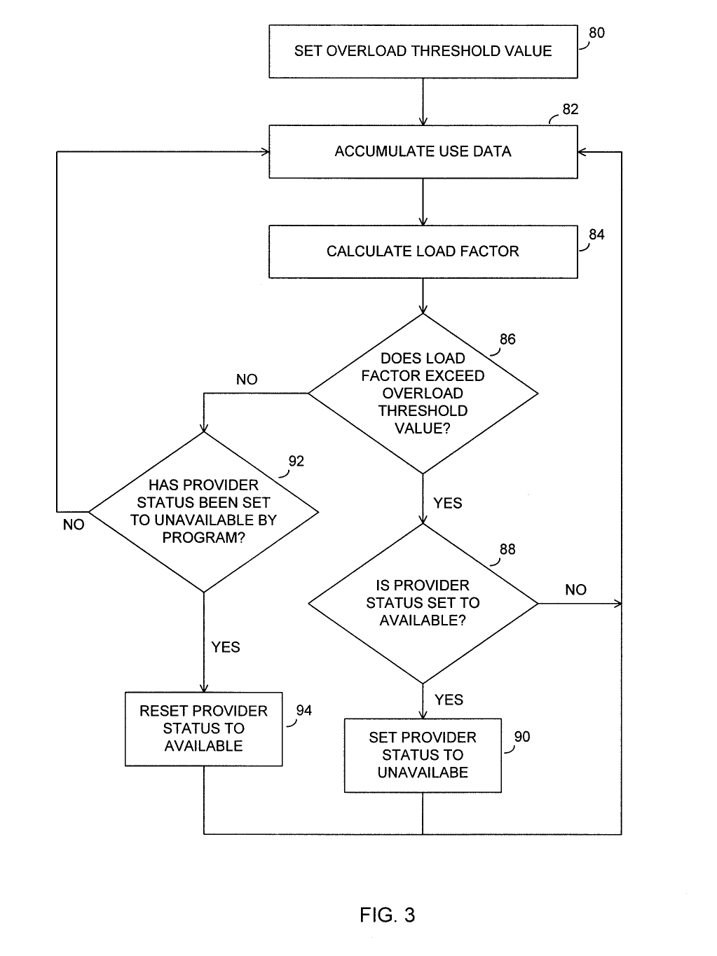

With reference to FIG. 3, there is illustrated a flow chart of operations of the load monitoring program of one of the service providers 14 of FIG. 1, according to some embodiments of the present invention, for obtaining a load factor for an aggregate of services instances or a load factor for each service instance, when the service provider has a plurality of service instances. A presence generating program may generate the provider presence information, such as that illustrated in FIG. 2. In some embodiments, the load monitoring program may interface with the presence generating program to provide one or more load factors to be included in the provider presence information. Additionally, in some embodiments, the load monitoring program may cause the presence generating program to reset the provider status of the provider presence information. The presence generating program is also responsible for delivering the provider presence information to the network interface so that it may be sent to the IM server 12.

In an operation 80, the load monitoring program may set an overload threshold value, with the value being for a given service instance or aggregate of service instances (e.g., the service provider in general). In an operation 82, the load monitoring program may monitor the usage of the instance or aggregate of instances and record usage data, such as hits per time unit and/or response times over a period of time. In an operation 84, the load monitoring program may calculate the load factor based on the usage data. In an operation 86, the load monitoring program may compare the calculated load factor with the overload threshold value to see if the load factor exceeds the overload threshold value.

If the calculated load factor does exceed the overload threshold value in operation 84, then in an operation 88, the load monitoring program may determine if the provider status is set to “available”. If the provider status is not set to available (unavailable), then the load monitoring program may loop back to operation 82, where in may accumulate usage data for another period of time. If the provider status is set to available, then in an operation 90, the load monitoring program may command the presence generating program to change the provider status to “unavailable” and may loop back to the operation 82 where the load monitoring program may accumulate data for another period of time. In other words, the load monitoring program causes the provider status to be changed. When the load factor for the given service instance or aggregate of service instances is exceed, this means that there is the previously described “overload condition”.

If the calculated load factor does not exceed the overload threshold value in operation 86, then that means the load factor is less than or equal to the overload threshold value. In an operation 92, the load monitoring program may determine if the provider status was previously reset to “unavailable” in the operation 90. If yes, then in an operation 94, the load monitoring program may command the presence generating program to reset the provider status by changing it back to “available”. If no, then the provider status has been set to “unavailable” for other reasons independent of operation 90; hence, the load monitoring program loops back to accumulate usage data for another period of time.

In the above described operation of FIG. 3, the load monitoring program uses the presence generating program to modify the provider presence information. In other embodiments, the load monitor program may command a server presence program (to be described hereinafter) to modify the provider presence information at one of the IM servers 12. Likewise, in the above described operation of FIG. 3, the load monitoring program is assumed to be located at the service provider 14 being monitored. In other embodiments, the load monitoring program may be distributed to a location other than the service provider 14 being monitored.

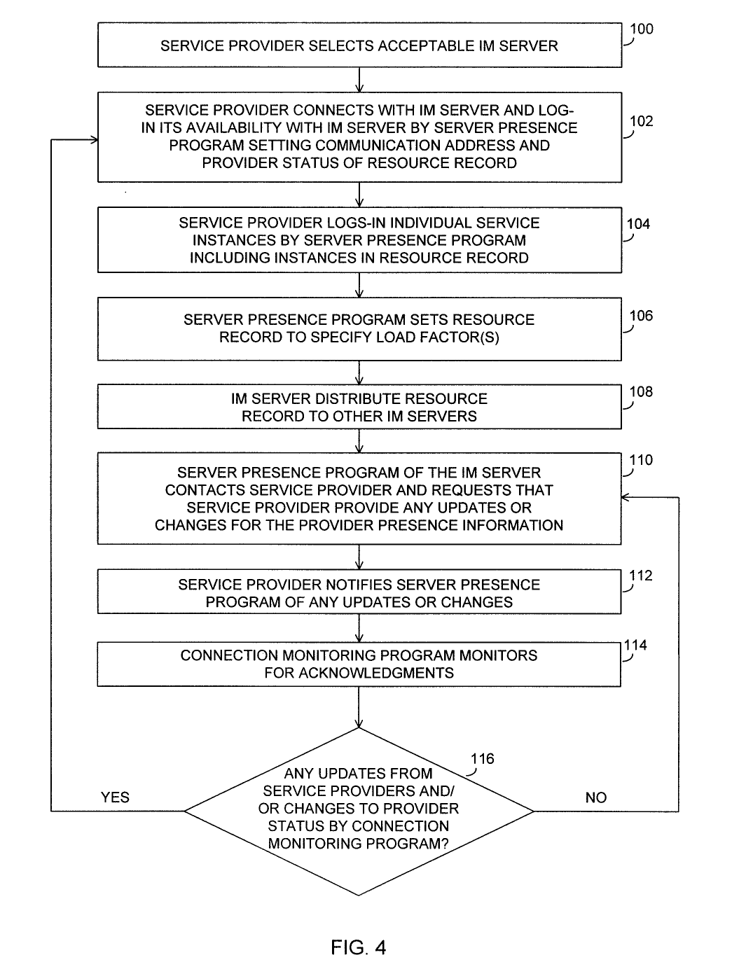

With reference to FIG. 4, there is illustrated a flow chart of operations of the server presence program of the IM system 10 of FIG. 1, according to some embodiments of the present invention, for obtaining provider presence information from the service providers 14 and for forming the resource records 30. With reference to FIGS. 1-4, in a given service provider 14, once a service is loaded, specific service instances of the service may be opened for use. In an operation 100, a given service provider 14 may select an acceptable IM server 12 to which it may upload its provider presence information. A good IM server 12 is one having the functionality to receive, store and distribute the provider presence information, in addition to client presence information.

In an operation 102, a service provider 14 may connect with an IM server 12 and may log-in its availability with the IM server 12. More specifically, once the service provider 14 is connected, the server presence program may set the “provider status” of a resource record 30 for the connected service provider 14 to “available” (or other designation, as appropriate), based upon the provider presence information provided by the connected service provider 14. The IM server 12 may also include the communication address of the connected service provider 14 in the resource record 30.

In an operation 104, the service provider 14 may log-in individual service instances of one or more services, with such service instances being available at the service provider 14. More specifically, the execution of the server presence program at the IM server 12 may set the resource record 30 in the IM server 12 to describe what service instances are available from the connected service provider 14, based upon the provider presence information provided by the service provider 14. Hence, these service instances are associated with the connected service provider 14.

In some embodiments, in an operation 106, the server presence program also may set the resource record 30 to specify one or more load factors. As previously described, there may be a single load factor for an aggregate of instances (or just for the service provider 14). In other embodiments, there may a load factor for each listed service instance. In some embodiments, in this operation “service qualifying characteristics” (presence elements for hosting environment, interfaces, capabilities, location, and/or like elements, as defined above) may also be included.

In an operation 108, the IM server 12 receiving the provider presence information from the service provider 14 may distribute its resource record 30 to other IM servers 12 connected to the network 18. For example, the network 18 may include the internet and the resource record 30 may be distributed over the internet to the other IM servers 12. In FIG. 1, these IM servers are illustrated as being in different locations, such as Asia, Brazil, Europe and Oregon.

In some embodiments, the server presence program of the IM server 12 may obtain updates or changes for the provider presence information from the service providers 14. With respect to such updates, the server presence program may update the resource record 30 for that service provider 14 contained in the memory. In some embodiments, as illustrated in FIG. 4, the server presence program may loop back and obtain the updates or changes to the provider presence information on a fetching basis (e.g., periodically polling the service provider 14). However, this is just one possibility for obtaining updates and other implementations of the updating process may be undertaken. For example, in some embodiments, the service provider 14 may notify the IM server 12 when there is a change in its provider presence information; in which case, the server presence program updates the resource record 30 on a notification or subscriber basis.

In an operation 110, the server presence program of the IM server 12, after a delay, may contact the service provider 14 and requests that the service provider 14 provide any changes or updates of the provider presence information, if any, contained in its resource record 30 (including adding or subtracting elements of the provider presence information). In operation 112, the service provider 14 notifies the server presence program as to whether there are any updates or changes.

In general, the connection monitoring program of the IM server 12 may monitor links between the IM server 12 and the server provider 14 providing the provider presence information. If the connection monitoring program determines that the links are impaired or busy and therefore cannot efficiently provide or update its provider presence information in response to the update request in operation 112, then the connection monitoring program may a request to the server presence program to change the provider status of the service provider 14 from “available” to “unavailable”. The link monitoring program may monitor different network information and seek to modify the provider presence information for other purposes and the following describes only one illustrative example.

In this illustrative example, the IM server 12 and the service provider 14 may be set up as follows. Upon the server presence program sending its request to the service provider 14 in the operation 110 for updates or changes to the provider presence information, in an operation 114, the connection monitoring program may always expect at least an acknowledgment to be returned by the service provider. Receipt of updates or changes to the presence information may be in addition to the acknowledgment or a substitute for the acknowledgment. For the purposes herein, receipt of the updates or changes will be considered an “acknowledgment”. If the service provider has no updates or changes, then it must affirmatively generate an acknowledgment. Receipt of the acknowledgment by the IM server 12 would indicate that the provider presence information currently in the resource record 30 for the service provider 14 is still valid and also that the links between the service provider 14 and the IM server 12 are able to convey the acknowledgment; hence, the links are not busy or impaired.

In the operation 114, the connection monitoring program, in response to the IM server 12 not receiving an acknowledgment in a given time period, may send a command to the sever presence program to change the provider status from “available” to “unavailable”. Likewise, in the operation 114, if the IM server does receive an acknowledgment in the given period of time and the connection monitoring program determines that it had previously directed the server presence program to change the provider status to “unavailable” from “available”, then the connection monitoring program may command the server presence information to reset the provider status to “available”.

In an operation 116, the server presence program may determine if it received any updates in the operation 114 from one or more service providers 14 and/or whether the connection monitor program commanded any changes to the provider status. If there are updates or changes and/or commands to change the provider status, then the server presence program loops back to a point in its program where it may update resource record(s) 30. If there are no updates or changes or commanded changes, then the server presence program, after a delay, may loop back to check the service providers 14 again. This procedure for obtaining updates and changes may be repeated for each service provider establishing a resource record 30 or may be undertaken for all the service providers at one time.

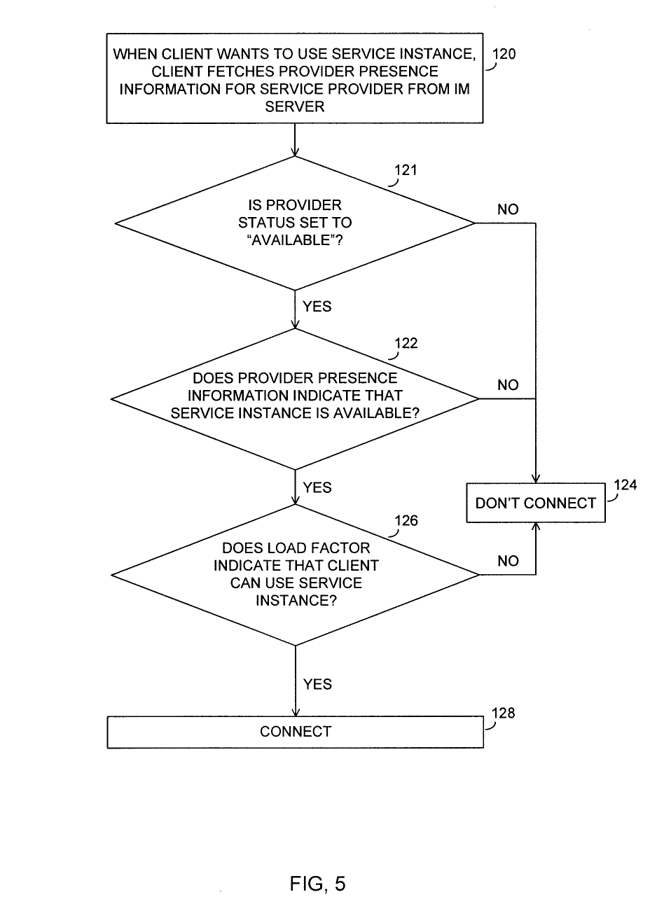

With reference to FIG. 5, a flow chart of the presence service of the IM system 10 of FIG. 1, according to some embodiments of the present invention, is shown for distributing the provider presence information to a given client 16. Also, the flow chart of FIG. 5 shows the operations of the client 16 for receiving and using the provider presence information. In general, a client presence program may receive and process the client presence information obtained from the IM server 12. Depending on the configurations of the server presence program of the IM server 12 and the client presence program in the watcher client 16, the presence service may configure the watcher client 16 to be a “fetcher” or a “subscriber”, as previously defined. The flow chart of FIG. 5 is illustrated with the client 16 as being a fetcher.

With respect to FIGS. 1 and 5, when the watcher client 16 wants to use a particular service instance of a service provider 14, in an operation 120, the client presence program of the watcher client 16 may fetch the provider presence information (e.g., resource record 30) for that service provider 14 from the IM server 12, if available. In an operation 121, the client presence program may determine if the provider status is set to “available”. If it is set to “available, the client presence program proceeds to an operation 122 and if it is set to “unavailable, the client presence program proceeds to an operation 124 (no connection). In the operation 122, the client presence program may determine if the service instance is available by inspecting the list of service instances, if any, in the provider presence information for the service provider 14. If the provider presence information does not indicate that the particular service instance is available, then in an operation 124, the client 16 would not connect to the service provider 14.

If the provider presence information indicates that the particular service instance is available, then in an operation 126, the client presence program of the watcher client 16 may evaluate or examine the load factor of the provider presence information to determine whether to use the service instance. For example, if the load factor does not exceed an upper limit of an acceptable range for the load factor, then the service provider or service instance may be selected. In other embodiments, additional service qualifying characteristics may be included in the selection process. As another example, the watcher client 16 may have located essentially the same service instance at a number of service providers 14 and may select the one with the lowest load factor. Alternatively, the previously-mentioned service selection characteristics may be considered prior to or in conjunction with the load factor in deciding whether to connect to the service instance. In summary, at least one selection criterion is based at least in part on the load factor.

If the client presence program decides to connect, then the presence service may proceed to operation 128, where the client uses the communication address from the provider presence information to connect with the service provider 14 having the particular service instance. If the client presence program decides not to connect, then the client presence program may proceed to operation 124.

In some embodiments, the operations 122 through 128 may be undertaken by the client presence program without the intervention of the user of the client 16. In some embodiments, the operations 122 through 128 may be manually undertaken by the user of the client 16. The provider presence information may be displayed by the client presence program, for example on a monitor of the client 16, so as to allow the user of the client 16 to inspect the provider presence information and make a determination of whether the client 16 wants to connect to the service provider 14 to obtain the particular service instance. In other embodiments, a searchable service directory may be created from the provider presence information. In some embodiments, the client presence program may select a service provider or an instance of a service provider based on service selection criteria that include at least the provider status being available and there being an acceptable load factor.

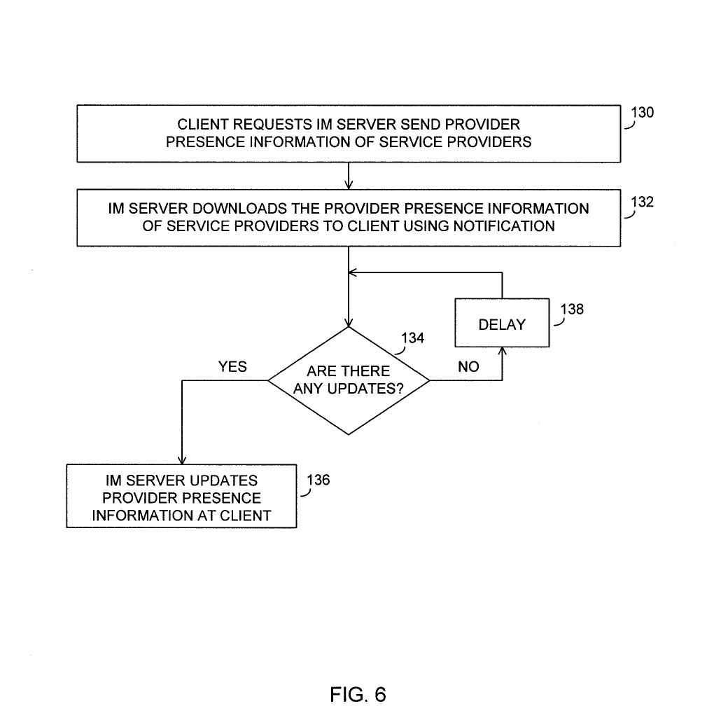

FIG. 6 illustrates a flow chart of operations of a server presence program, according to another embodiment of the present invention, for downloading and updating the provider presence information on a notification basis to the watcher clients 16. With respect to FIGS. 1 and 6, in an operation 130, the watcher client 16 may initially request that the server presence program of the IM server 12 download the provider presence information, for example, from a number of service providers 14. In an operation 132, the server presence program of the IM server 12 may download the provider presence information (e.g., resource records 30 of FIG. 2) for a plurality of service providers 14 to the client 16. In an operation 134, the server presence program may check to see if the IM server 12 has received any updates for the provider presence information previously downloaded to the client 16. The server presence program may periodically check to see if it has received updates. If there are updates, in an operation 136, the server presence program of the IM server 12 may send the updates to the client 16 to update the provider presence information using notification. If there are no updates, then with a delay at operation 138, the server presence program may loop back and check again later.

FIG. 6 shows how the fetching and soliciting functions may be switched for the watcher client 16, with the client 16 being configured to obtain updates to the provider presence information through notification from the IM server 12, instead of fetching this information as undertaken in FIG. 5. In other embodiments, the server presence program of the IM server 12 may provide updates or changes to the client 16 when they are received from the service providers 14 instead of periodically checking to see if it has received updates. In other embodiments, the watcher client 16 may fetch the updates or changes from the IM server 12 (e.g., periodically poll the IM server 12 to obtain the updates).

The IM system 10, according to some embodiments of the present invention, may provide an open, standard, and infrastructure-aware mechanism for clients 16 to locate and use service providers 14. By keeping the information as part of the infrastructure (e.g. the data transport system of the IM servers 12), not only are the clients 16 and IM servers 12 free from having to have their own, separate systems, but the infrastructure itself may be enabled to “weed out” clients and services that aren't compatible with (or even well-suited to) each other.

The IM service of the IM server 12, according to the some embodiments of the present invention, may be utilized to overcome firewall issues as instant messaging is typically added as an additional layer to the TCP/IP stack. Hence, by utilizing the established IM service, firewall issues may be reduced in the IM system 10.

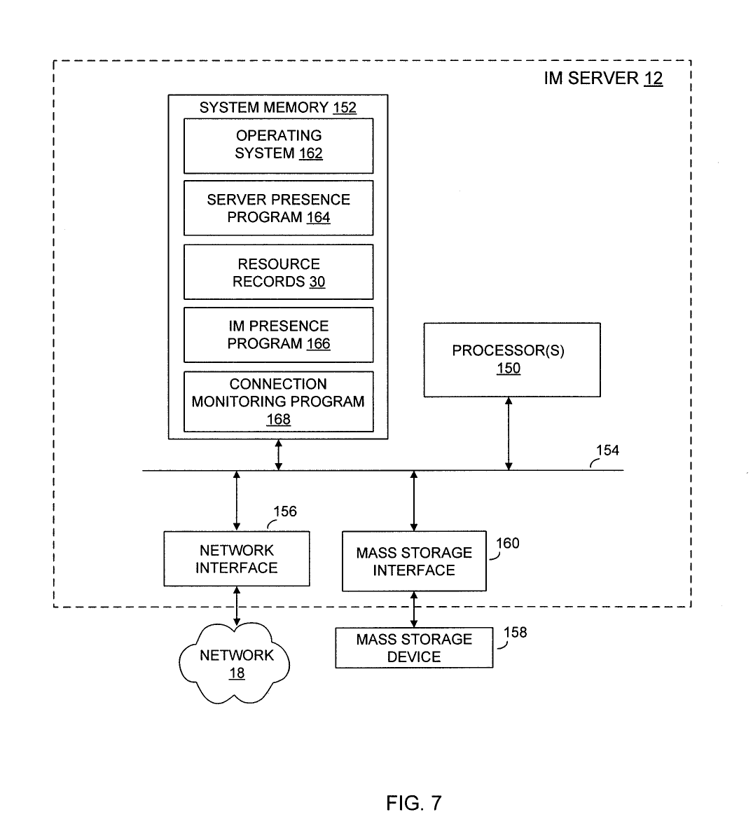

With reference to FIG. 7, an exemplary IM server 12 of FIG. 1, according to some embodiments of the present invention, is shown. The IM server may include one or more processor(s) 150, a system memory 152, and a system bus 154, which joins the system memory 152 to the processor(s) 150. There may be one or more processors 150. A network interface 156 may couple the network 18 to the IM server 12 via the bus 154. A mass storage device 158 may be coupled to the bus 154 by way of a mass storage interface 160. The system memory 152 may include random access memory (RAM) for containing an operating system 162, a server presence program 164, the resource records 30, an IM presence program 166, and a load monitoring program 168. The IM server 12 may include a number of other components.

The system memory 152 also may include read only memory with a basic input/output system (BIOS) that contains basic routines, such as for loading the operating system 162 from the mass storage device 158 to the RAM of the system memory 152 during start-up or reboot. Likewise, once loaded, the operating system 152 may load the server presence program 164 from the mass storage device 158. Generally, the resource records 30 may be created and maintained in the RAM of the system memory 152. The server presence program 164, when executed by the processor(s) 150, may provide the previously described presence service wherein the IM sever 12 obtains provider presence information from one or more service providers, may form resource records 30 for the service providers, and may distribute the provider presence information to watcher clients. In some embodiments, the server presence program, when executed by the processor(s) 150 may perform the operations of FIGS. 4 and 6. The IM presence program 166, when executed by the processor(s) 150, may provide the previously described presence service wherein the IM sever 12 obtains client presence information from one or more presentity clients and distribute the client presence information to watcher clients to support the IM service.

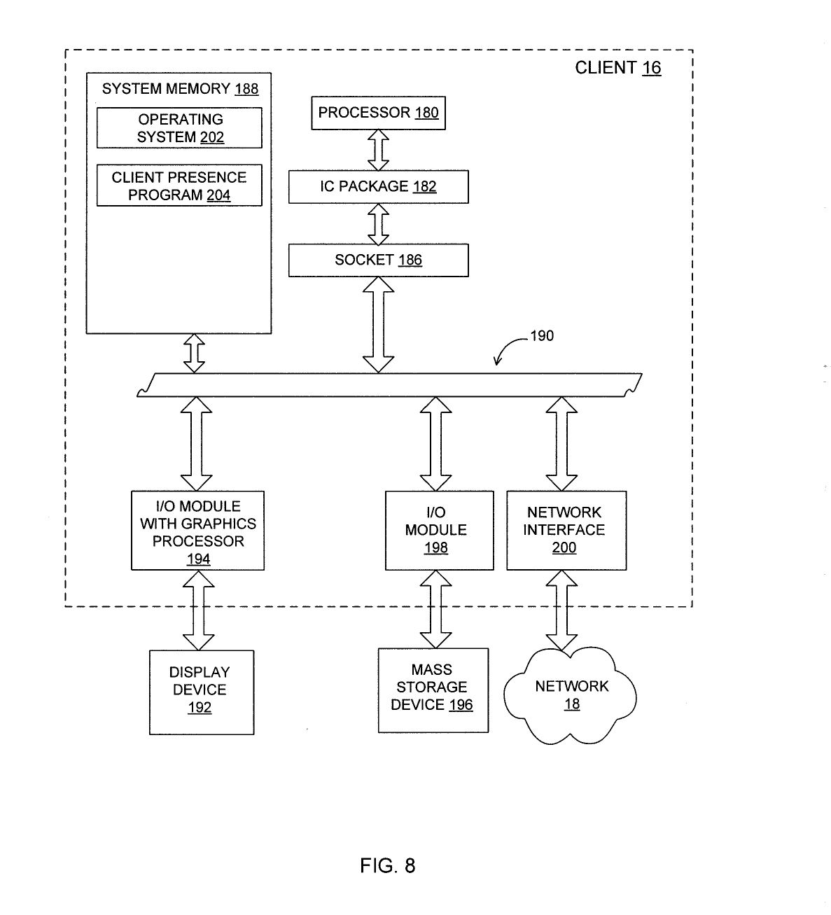

With reference to FIG. 8, there is illustrated an exemplary client 16 which may form part of the IM system of FIG. 1, according to some embodiments of the present invention. The client 16 may include a processor chip or die 180 which is part of an integrated circuit (IC) package 182. The IC package 182 may be mounted on a substrate or printed circuit board (PCB) 184 via a socket 186. The processor chip 180 of the IC package 182 may be a processor and the PCB 184 may be a motherboard. However, in other systems the IC package 182 may be directly coupled to the PCB 184. In addition to the socket 186 and the IC package 182, the PCB 184 may have mounted thereon a system memory 188 and a plurality of input/output (I/O) modules for external devices or external buses, all coupled to each other by a bus system 190 on the PCB 184. More specifically, the client 16 may include a display device 192 coupled to the bus system 190 by way of an I/O module 194, with the I/O module 194 having a graphical processor and a memory. The I/O module 194 may be mounted on the PCB 184 or may be mounted on a separate expansion board. The client 16 may further include a mass storage device 196 coupled to the bus system 190 via an I/O module 198. The network 18 may be coupled to the bus system 190 via an I/O module (network interface) 200. Additional I/O modules may be included for other external or peripheral devices or external buses.

The system memory 188 may include an operating system 202 and a client presence program 204. The system memory 188 may include read only memory having may include a basic input/output system (BIOS) that contains basic routines, such as for loading the operating system 202 from the mass storage device 196 to the system memory 188 during start-up or reboot. Likewise, once loaded, the operating system 202 may load the client presence program 204 from the mass storage device 196. The client presence program 204, when executed by the processor(s) 180, may fetch or receive by notification the provider presence information from the IM client via the network interface 200, which is coupled to the network 18. The provider presence information may be displayed on the display device 192. In one embodiment, the client presence program 204, when executed by the processor(s) 180, may perform the operations of FIG. 5.

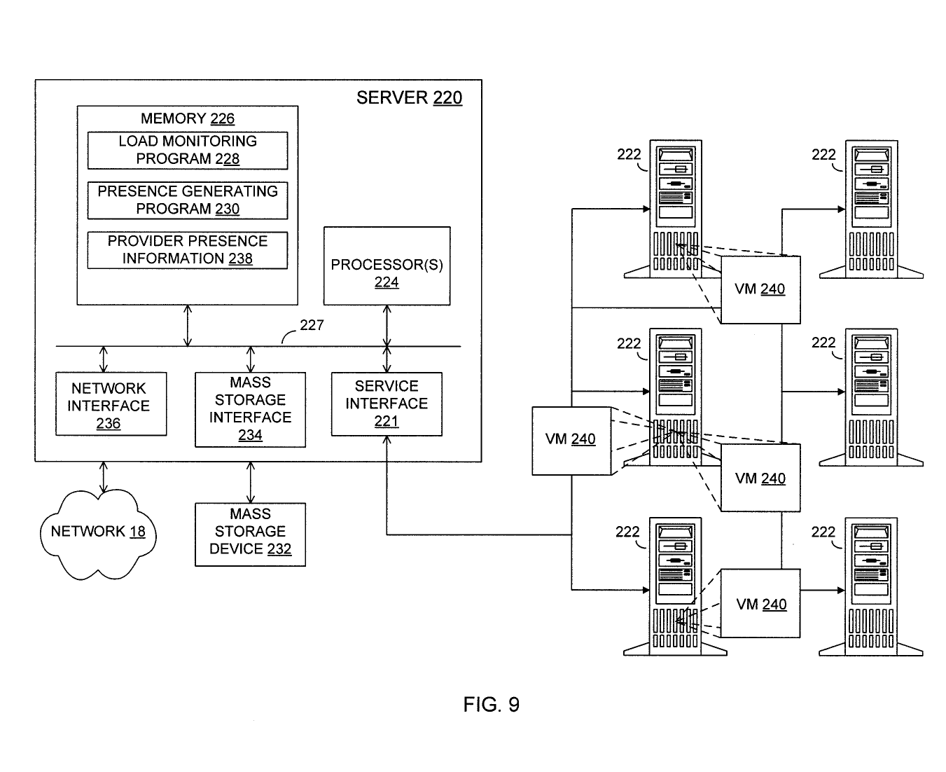

With reference to FIG. 9, an illustrative service provider 14 which may be used in the IM system 10 of FIG. 1, according to some embodiments of the present invention, is shown. The service provider 14 may have at least one computer server 220 coupled directly to the network 18, with the server 220 having a service interface 221. In some embodiments, the service provider 14 may have a number of servers 222 coupled to the service interface 221 of the server 220. The service interface 221 of a service provider 14 may receive service requests from clients via the network 18 and may allow for the servers 220 and 222 to share information. The server 220 may include a processor 224 (or processors) and a system memory 226. The processor(s) 224, memory 226, and service interface 221 may be interconnected via a bus 227. The memory 226 may have a load monitoring program 228 and a presence generating program 230 loaded from a mass storage device 232, with the mass storage 232 being coupled to the bus 227 by way of a mass storage interface 234. The network 18 may be coupled to the bus 227 by way of a network interface 236.

The presence generating program 230, when executed by the processor(s) 224, may generate provider presence information 238, which may be at least temporarily held in the memory 226. In one embodiment, the provider presence information 238 may be illustrated by that shown in FIG. 2. The load monitoring program 228, when executed by the processor(s) 224, may perform operations such as those shown in FIG. 3. The network interface 236, which is coupled to the processor(s) 224 and the memory 226, may send the provider presence information 232 over the network 18 to an instant messaging (IM) server, such as illustrated in FIG. 7.

In some embodiments, the service provider 14 may configure one or more servers 222 to have application software to provide one or more service instances having a particular hosting environment. This configuration may be fixed; hence, to offer other instances of services needing different, incompatible hosting environment elements, the service provider 16 may configure another server 222 with the other instances of services. In general, the service instances may be provided from different servers 220 and 222 with different service qualifying characteristics.

In some embodiments, one or more of the servers 220 and 222 of the service provider 14 may be configured to provide one or multiple virtual machines (VMs), which are illustrated in FIG. 9 as VMs 240. Rather than configuring individual machines or serves to offer services in multiple fixed combinations as described above, the VMs 240 may offer different service instances with different service qualifying characteristics. In some embodiments, a given VM 240 may offer multiple service instances, and a given service instance may be offered by multiple VMs 240. In some embodiments, different VMs 240 may offer different service instances. In some embodiments, different VMs 240 also may offer otherwise identical service instances with different service qualifying characteristics (e.g., different hosting environments). In some embodiments, the VMs may be created and deleted as needed, and may be installed on any available (or desired) server.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is manifestly intended that this invention be limited only by the claims and the equivalents thereof.

What is claimed is:

1. A system, comprising:
a service provider including a memory and a processor coupled to the memory, with the service provider being adapted to provide at least one service instance;
a presence generating program adapted to be located in the memory;
the processor adapted to execute the presence generating program to generate provider presence information, with the provider presence information including a provider status; and
a load monitoring program, in communication with the service provider, to generate at least one load factor in response to monitoring the at least one service instance.

2. The system according to claim 1, wherein
the service provider further includes a network interface coupled to the processor and the memory; and
the presence generating program is further adapted to send the provider presence information to an instant messaging (IM) server by way of the network interface.

3. The system according to claim 2, wherein a selected one of the presence generating program at the service provider and a server presence program at the IM server is disposed in communication with the load monitoring program and, in response to receiving the at least one load factor from the load monitoring program, is adapted to include the at least one load factor in the provider presence information.

4. The system according to claim 3, wherein the provider presence information further includes the at least one service instance.

5. The system according to claim 4, wherein
the at least one service instance included in the provider presence information is a plurality of service instances; and
the at least one load factor included in the provider presence information is a plurality of load factors, with there being one of the plurality of load factors associated with each of the plurality of service instances.

6. The system according to claim 4, wherein
the at least one service instance included in the provider presence information is a plurality of service instances; and
the at least one load factor included in the provider presence information is a single load factor associated with all or part of the plurality of service instances.

7. The system according to claim 2, wherein the load monitoring program includes an overload threshold value and is adapted to make a comparison of the at least one load factor with the overload threshold value and to set the provider status based upon the comparison.

8. The system according to claim 2, wherein
the load monitoring program is disposed to be in communication with the presence generating program and is adapted to be located in the memory and to be executed by the processor; and
the presence generating program, in response to receiving the at least one load factor from the load monitoring program, is adapted to modify the provider presence information to include the at least one load factor.

9. An instant messaging (IM) server, comprising:
a memory;
a server presence program adapted to be located in the memory;
a processor coupled to the memory and adapted to execute the server presence program to receive client presence information from at least one presentity client, to store the client presence information in the memory, and to distribute client presence information to at least one IM watcher client; and
the processor being further adapted to further execute the server presence program to receive provider presence information for at least one service provider, to store the provider presence information in the memory, and to distribute the provider presence information to at least one service watcher client, with the provider presence information for the at least one service provider including a provider status and at least one load factor.

10. The IM server according to claim 9, further comprising:
a connection monitoring program, adapted to be located in the memory and to be in communication with the server presence program, to generate a presence-changing request based at least in part on a network condition; and
the server presence program, in response to the presence-changing request from the connection monitoring program, being adapted to modify the provider presence information.

11. The IM server according to claim 10, wherein the server presence program, in response to the presence-changing request from the connection monitoring program, is adapted to modify the provider status of the provider presence information.

12. The IM server according to claim 9, further comprising:
a connection monitoring program adapted to be located in the memory and in communication with the server presence program;
a network interface coupled to the memory and the processor; and
the processor adapted to execute the connection monitoring program to monitor at least one link coupled to the network interface for a link impairment and, upon detecting the link impairment, to request the server presence program to change the provider presence information.

13. The IM server according to claim 12, wherein the server presence program, upon detecting the link impairment, is further adapted to change the provider presence information by changing the provider status to unavailable if the provider status was set to be available.

14. The IM server according to claim 9, wherein
the server presence program is disposed to be in communication with a load monitoring program and is adapted to generate the at least one load factor based at least in part on monitoring at least one service instance of the at least one service provider; and
the server presence program, in response to receiving the at least one load factor from the load monitoring program, is adapted to modify the provider presence information to include the at least one load factor.

15. The IM server according to claim 14, further comprising a network interface coupled to the memory and the processor; and wherein the server presence program is coupled to the load monitoring program by way of the network interface.

16. The IM server according to claim 14, wherein the load monitoring program includes an overload threshold value and is adapted to make a comparison of the at least one load factor with the overload threshold value and to set the provider status based upon the comparison.

17. The IM server according to claim 9, wherein the provider presence information further includes at least one service instance associated with the at least one service provider.

18. The IM server according to claim 17, wherein the at least one service instance is a plurality of service instances associated with the at least one service provider and the at least one load factor is a plurality of load factors, with there being one of the plurality of load factors associated with each of the plurality of service instances.

19. The IM server according to claim 17, wherein the at least one service instance is a plurality of service instances associated with the at least one service provider and the at least one load factor is a single load factor associated with all or part of the plurality of service instances.

20. An article comprising a machine-readable medium that contains instructions of a server presence program for an instant messaging (IM) server, which when executed by the IM server, causes the IM server to perform operations comprising:
receiving client presence information by the IM server from at least one presentity client;
storing the client presence information in a memory of the IM server;
distributing the client presence information by the IM server to at least one IM watcher client;
receiving provider presence information by the IM server for at least one service provider, with the provider presence information for the at least one service provider including a provider status and at least one load factor;
storing the provider presence information in the memory of the IM server; and
distributing the provider presence information by the IM server to at least one service watcher client.

21. The article according to claim 20, further comprising:
a connection monitoring program adapted to be located in the memory and to be in communication with the server presence program; and
the server presence program, in response to a request from the connection monitoring program, being adapted to modify the provider presence information based at least in part on a network condition.

22. The article according to claim 20, wherein the provider presence information further includes the at least one service instance associated with the at least one service provider.

23. The article according to claim 20, wherein the at least one service instance is a plurality of service instances associated with the at least one service provider.

24. The article according to claim 23, wherein the at least one load factor is a plurality of load factors, with there being one of the plurality of load factors for each of the plurality of service instances.

25. The article according to claim 23, wherein the at least one load factor includes a single load factor for the at least one service provider.

26. A client computer system, comprising:
a memory, a mass storage device and a processor coupled to each other;
a client presence program adapted to be stored in the mass storage device and to be moved to the memory by the processor; and
the processor being adapted to execute a client presence program to receive provider presence information for at least one service provider from an instant messaging (IM) server and to store the provider presence information in the memory, with the provider presence information for the at least one service provider including a provider status and at least one load factor.

27. The client computer system according to claim 26, further comprising:
a network interface coupled to the processor and adapted to send a service request to the at least one service provider in the event that the provider presence information meets service selection criteria including at least the provider status being available and a criterion based at least in part on the at least one load factor.

28. The client computer system according to claim 26, wherein the provider presence information further includes the at least one service instance associated with the at least one service provider.

29. The client computer system according to claim 26, wherein the at least one service instance is a plurality of service instances associated with the at least one service provider; and the at least one load factor is a plurality of load factors, with there being one of the plurality of load factors for each of the plurality of service instances.

30. The client computer system according to claim 28, wherein the at least one service instance is a plurality of service instances associated with the at least one service provider and the at least one load factor includes a single load factor associated with the at least one service provider.
